(19) United States
(12) Patent Application Publication
(10) Pub. No.: US 2005/0102227 A1
(43) Pub. Date: May 12, 2005

(54) Electronic commerce method and system utilizing integration server

(76) Inventor: Aleksey Solonchev, Torrance, CA (US)

Correspondence Address: ALEKSEY SOLONCHEV, 21010 ANZA AVE #28, TORRANCE, CA, 90503, US

(21) Appl. No.: 10/605,949

(22) Filed: Nov. 9, 2003

(51) Int. Cl. G06F 17/60

(52) U.S. Cl. 705/39; 705/27

(57) ABSTRACT

An electronic commerce system integrating plurality of content provider servers with plurality of merchant servers having integration server communicating request for commercial transaction to at least one merchant server, thus enabling the user of the client computer connected to the content provider server to initiate commercial transactions to at least one merchant server without being redirected to the merchant server away from the content provider server. The system increases customer retention on the content provider server, thereby increasing incentive for content providers to join the commerce system, thereby increasing the number of sites advertising products offered by merchants. The system also simplifies integration of multitude of servers, thereby reducing cost and time required for such integration.

### BACKGROUND OF INVENTION

The invention relates to systems for the purchase of goods and services over a communications network. More specifically, the invention is a method and apparatus for seamlessly integrating plurality of content provider servers with plurality of merchant servers into an electronic commerce system.

One of the primary applications of the Internet is electronic shopping, i.e. the purchase of goods and services, i.e. products. Virtually every major commercial “bricks and mortar” merchant has established a Web site for the showcase and sale of their products. Further many manufacturers sell products directly over the Web. Finally, a plethora of on-line merchants, not previously existing in the bricks and mortar world, have come into existence. As a result, virtually every product is available for purchase over the Web from a plurality of merchants.

However, the inability for the various merchants to get out the message on their products and services effectively or efficiently leaves the merchant's corresponding Web sites largely unknown to the potential customers.

In an attempt to rectify this problem, there has been an effort to expand customer knowledge of various merchant's on the web by use of traditional advertising that is adapted to web technology. For example, the use of glossy banner ads touting a product has now become reasonably common at a number of popular sites. These banners combine graphics and text into an appealing display triggering interest in the customer as they visit the site displaying the banner. By clicking on the banner, the customer is transported to the merchant site associated with the banner.

One of popular implementations of this advertising idea is affiliate marketing. Pioneered by Amazon.com in 1996, affiliate marketing is a simple way for Web sites owners to generate revenue by directing traffic toward other sites. An affiliate partner promotes products and services on its Web site for a commission. Affiliates agree to place links to merchant online businesses on their Web sites for the purpose of promoting merchant's products and/or services.

Further improved by U.S. Pat. No. 5,991,740 and implemented by LinkShare.com the affiliate marketing system includes a clearinghouse site monitoring purchases made by a customer directed to the merchant site and allocating credit to the affiliate partner provided said direction.

U.S. Pat. No. 5,991,740 discloses data processing system for establishing, managing and tracking commercial transactions undertaken on a wide access network, comprising a Clearinghouse site, a Content Provider site displaying information about one or more products or services available for commercial transactions and linking instructions for directing a customer's viewing program to a Target Merchant site, wherein the Target Merchant site is programmed to record information about a purchase and to communicate said purchase information to the Clearinghouse site, wherein said purchase information is used by the Clearinghouse site to allocate credit to the Content Provider.

While creating increased traffic for the merchant Web site, the system disclosed in U.S. Pat. No. 5,991,740, as well as systems implementing other variants of the affiliate marketing, requires that the customer navigate to the merchant Web site away from the content provider site and execute the purchase transaction directly on the merchant Web site. This reduces value of the system for the content provider because the customer may never come back to the content provider site and the purchase made will be associated by the customer with the merchant Web site. This constitutes the problem with the affiliate marketing system—by implementing such system content providers reduce customer retention value for their sites driving customers away to the merchants' Web sites.

Customer retention is important to most companies because the cost of acquiring a new customer is far greater than the cost of maintaining a relationship with a current customer. A company that retains a lot of its customers also gains a good reputation and can attract future customers more easily. Customer retention is especially difficult with respect to electronic commerce when all it takes to switch to another Web site is clicking a mouse on a Web link or a banner. Once a customer has found a site through the Web, it is important that everything is done to retain that customer.

Recognizing the above, content providers design their sites specifically tailored toward maximum customer retention, however implementation of the affiliate marketing system works against this strategy.

Other attempts have been made in the industry to increase efficiency of markets by permitting customers to readily compare products and terms of sale from plural merchants and to purchase from more than one merchant Web site.

It is known to integrate a plurality of Web sites into a single environment known as a shopping portal. Shopping portals ordinarily include a Web server presenting an integrated interface displaying plural products from various merchants. However, conventional shopping portals merely serve as a gateway to the individual merchant Web sites. In particular, when a purchasing decision is made, the customer is directed to the merchant Web site and the purchase is completed manually through the merchant Web site. Accordingly, when purchases are made from more than one merchant, conventional shopping portals require that the customer execute the orders using different interfaces at the respective merchant Web sites.

U.S. Pat. No. 6,535,880 discloses an automated on-line commerce method and apparatus utilizing a shopping server, wherein a customer can select products for purchase from plural merchant servers by examining product information presented Web pages stored on shopping server and populated with product information from product database stored on the shopping server. The product information related to selected products is verified by accessing a checkout page of each merchant server. The verified information is then presented to the customer for confirmation. Upon confirmation, buy procedures are executed on each merchant server to purchase the products using existing account information for the customer at each merchant server. This method eliminates the need for the customer to visit each merchant Web site to complete the purchase.

However, the method disclosed in the U.S. Pat. No. 6,535,880 requires direct software interface and business process integration between a merchant server and a shopping server presenting products to customers. First, this makes it difficult for the shopping server to present products from multiple merchant servers which may have different software interfaces and may implement different business processes. Second, it requires establishing direct commercial relationships between merchant and the shopping server owner, which requires performing time consuming and expensive search for commercial partners, thus limiting the number of shopping servers presenting products from a merchant as well as the number of merchants presenting products on a shopping server. Further, complex enough procedure of integrating software and business process between a merchant server and a shopping server becomes even more complex in case of integration of plurality of merchant servers with plurality of shopping servers all of which may have different software interfaces and may implement different business processes.

There is another sector of the market that has been underserved by e-commerce merchants so far. Some Web sites providing content to their users do not position themselves as shopping sites and do not see their primary purpose in selling products to users. Nevertheless, such sites would like to provide their users with the opportunity to buy a product mentioned in the content if it does not create much distraction for the users.

However, the systems in place, similar to systems disclosed in the U.S. Pat. No. 5,991,740 or in the U.S. Pat. No. 6,535,880 mentioned above, either direct users to another Web site thereby reducing user retention on the content provider Web site, or require extensive efforts to integrate content provider Web site with every merchant Web site that sells products mentioned in the content thereby greatly reducing commercial value of the system.

Also, for a small content provider who wants to provide shopping abilities for users of its Web site, the cost of implementation of e-commerce functionality on the site or cost of integration with an existing e-commerce system may exceed commercial benefits of such integration or implementation.

### SUMMARY OF INVENTION

It is an object of the invention to seamlessly integrate plurality of content provider servers with the plurality of merchant servers into a single electronic commerce system.

It is another object of the invention to facilitate and reduce cost of the integration of a content provider server into the electronic commerce system.

It is another object of the invention to facilitate the integration of a merchant server into the electronic commerce system.

It is another object of the invention to permit a content provider to obtain all the commercial advantages of better customer retention combined with the presentation of plurality of merchants on the content provider server.

It is another object of the invention to permit a merchant to obtain all the commercial advantages of the presentation of merchant's products on plurality of the content provider servers.

To achieve these and other objects, a first aspect of the invention is a system for initiating and tracking commercial transactions, comprising at least one client computer, at least one content provider server, at least one merchant server programmed to provide the ability to execute commercial transactions, and an integration server having a database and programmed to identify the content provider server and the merchant server. The integration server is further programmed to store a product catalog comprising information regarding products available for commercial transaction, and to communicate product information to the content provider server. Content provider server is programmed to request from the integration server an information regarding products available for commercial transaction, and to communicate it to the client computer, and to receive from the client computer an integrated transaction request comprising an information regarding items selected for a commercial transaction, and to communicate the integrated transaction request to the integration server. The integration server is further programmed to create a merchant transaction request comprising an information regarding items selected for the commercial transaction on the merchant server, and to communicate the merchant transaction request to the merchant server.

A second aspect of the invention is a method of initiating and tracking commercial transactions, comprising the steps of identifying at least one content provider server to an integration server having a database comprising an information regarding products available for commercial transactions, communicating product information to said content provider server, communicating product information to a client computer, receiving from the client computer an integrated transaction request comprising an information regarding items selected for a commercial transaction, communicating said integrated transaction request to said integration server, creating a merchant transaction request comprising an information regarding items selected for the commercial transaction on the identified merchant server, communicating the merchant transaction request to the merchant server, and executing requested transaction on said merchant server.

### BRIEF DESCRIPTION OF DRAWINGS

FIG. 1 is a block diagram of a system in accordance with a preferred embodiment of the invention;

FIG. 2 is a block diagram of a portion of the system of FIG. 1 schematically illustrating components and interconnections of the client computer and the content provider server;

FIG. 3 is a block diagram of a portion of the system of FIG. 1 schematically illustrating components and interconnections of the integration server;

FIG. 4 is a block diagram of a portion of the system of FIG. 1 schematically illustrating components and interconnections of the merchant server;

FIG. 5 is a logic diagram depicting processing of a request for catalog by the content provider server;

FIG. 6 is a logic diagram depicting processing of a request for commercial transaction by the content provider server;

FIG. 7 is a logic diagram depicting processing of a request for commercial transaction by the integration server;

FIG. 8 is a logic diagram depicting processing of a request for commercial transaction by the merchant server.

### DETAILED DESCRIPTION

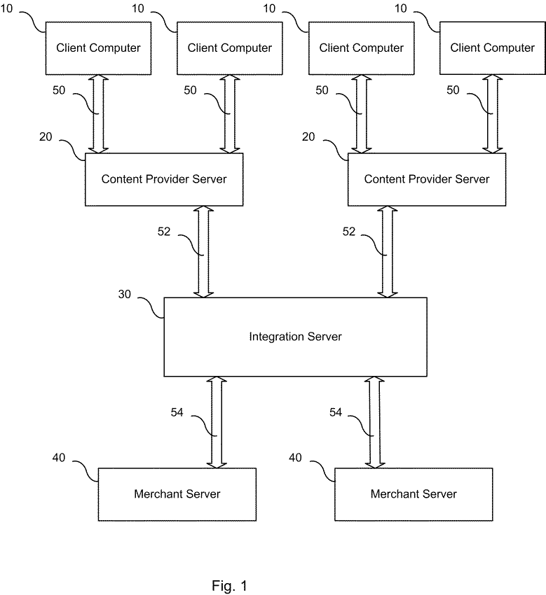

A preferred embodiment of the invention is illustrated in FIG. 1. Client computer 10 interconnected through the network connection 50 to content provider server 20. Content provider server 20 interconnected through the network connection 52 to integration server 30. Integration server 30 interconnected through the network connection 54 to merchant server 40.

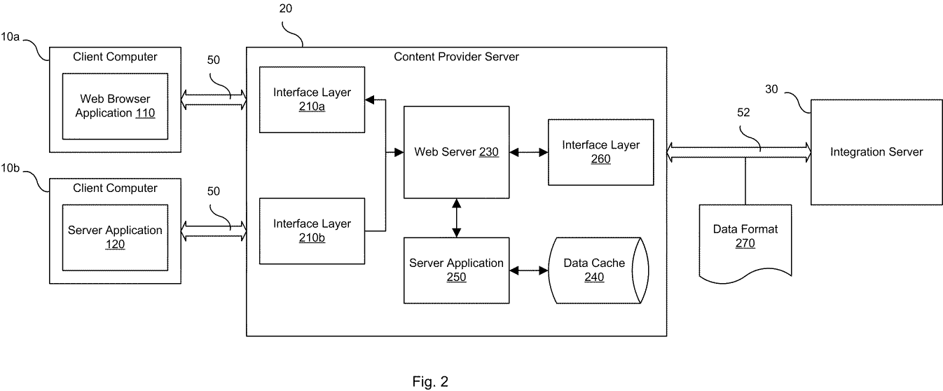

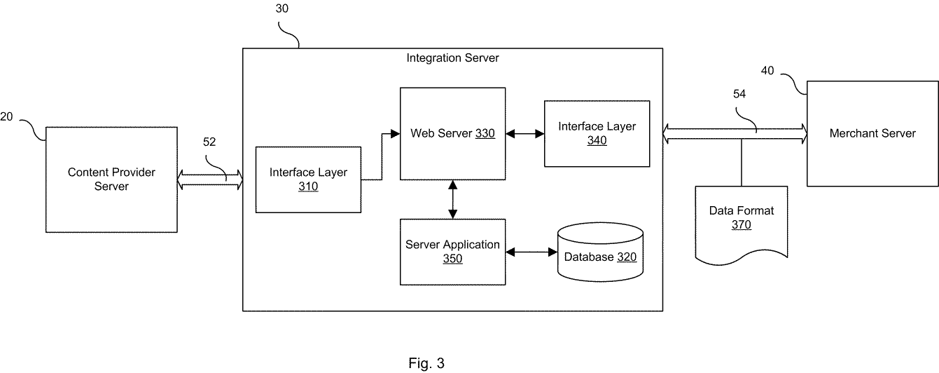

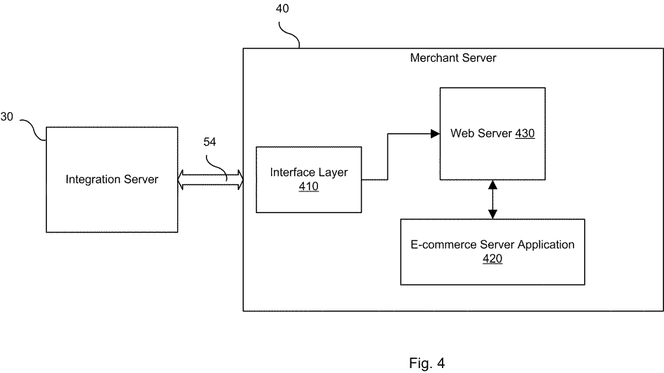

Network connections 50, 52, and 54 are conventional connections on a communication network to establish data communications with a single server or between multiple servers, for example Internet. Such communication network can include local area networks, wide area networks, intranets, extranets, and the Internet, and can utilize various data transmission mediums such as telecommunication service (wired and wireless, including traditional analog telecommunication lines), integrated service digital network (ISDN), an asymmetric digital subscriber line (ADSL), a very small aperture transmission (VSAT) satellite, a cable modem, or a T1 telecommunication line. Furthermore, other mechanisms for providing a network connection are known in the art. The invention is not limited to any particular method of providing a network connection.
it should be noted that a depiction of FIG. 1, as well as depiction of FIG. 2, FIG. 3, and FIG. 4, is logical in nature, and may be implemented in a variety of fashions. For example, content provider server 20, or integration server 30, or merchant server 40 can each be implemented in a single computer, or each server can comprise plurality of computers in a configuration known as “web farm”, and/or can comprise one or more computers in a configuration known as “application server”, and/or can comprise one or more computers in a configuration known as “database server”.

Client computer 10 executes an application capable of sending requests to and receiving response from the content provider server 20. FIG. 2 shows two most common examples of configuration of client computer 10.

FIG. 2 shows client computer 10a executing a conventional, off-the-shelf Internet Web browser application 110, having features and functions such as are common to popular Web browsers. Web browser application 110 is not limited to any particular type of Web browser. For instance, web browser application 110 might be the Internet Explorer, available from Microsoft Corporation of Redmond, Wash. Web browser application 110 provides a human interaction with the system. For instance, when a user selects a hyperlink from the web browser window on the screen of client computer 10a, web browser application 110 requests the document that is targeted by the hyperlink. In response, the document is downloaded to the client computer 10a, and web browser application 110 displays or otherwise renders the content specified by the document. Web browser application 110 uses network connection 50 to communicate data to and from interface layer 210a on the content provider server 20.

Interface layer 210a transforms data received from client computer 10a into a format being used by server application 250, and transforms data ready to be sent to the client computer 10a into a format required by web browser application 110. For instance, if server application 250 uses XML format for data representation, and web browser application 110 requires HTML format of data to be sent over the HTTP protocol, then interface layer 210a transforms HTTP requests received from web browser application 110 into the XML format, and transforms responses form the XML format to the HTML format to be sent over the HTTP protocol to the web browser application 110.

FIG. 2 also shows client computer 10b executing server application 120 which is capable of interaction with the content provider server without direct human involvement. Server application 120 can be a part of a conventional electronic procurement system programmed to perform automated search for products available form a group of suppliers or merchants. Server application 120 uses network connection 50 to communicate data to and from interface layer 210b on the content provider server 20.

Interface layer 210b transforms data received from client computer 10b into a format being used by server application 250, and transforms data ready to be sent to the client computer 10b into a format required by server application 120. For instance, if server application 250 and server application 120 both use XML format for data representation but require different XML schema definitions, then interface layer 210b transforms data between these two different XML representations of the data. An XML schema is used in XML to describe and constrain the content of an XML document.

Means for transforming data from one format to another are well known in the art, for instance Extensible Stylesheet Language Transformations (XSLT). The invention is not limited to any particular method of providing a data transformation.

It should be understood that the invention is not limited to any particular type of application executed by client computer 10. It can be any application capable of sending requests to and receiving response from the content provider server 20.

Web server 230 is a conventional, off-the-shelf web server, having features and functions such as are common to popular web servers. Web server 230 is not limited to any particular type of Web server. For instance, web server 230 might be the Microsoft Internet Information Server, available from Microsoft Corporation, Redmond, Washington, or the open source web server Apache, available from http://www.apache.org.

Server application 250 implements the business logic allowing data analysis and transformation according to the business rules as described in greater detail below.

Data cache 240 provides means for data storage on the content provider server 20 and may be implemented in a variety of fashions which are well known in the art. For example, data cache 240 can use computer memory to store data, or can utilize a conventional, off-the-shelf database server such as Microsoft SQL Server, available from Microsoft Corporation, Redmond, Wash.

Interface layer 260 implements functions similar to functions of interface layer 210a or 210b and transforms data from a format internally used by content provider server 20 to predetermined data format 270 used in communications between content provider server 20 and integration server 30 when a request is sent to integration server 30, and transforms data from data format 270 to the format internally used by content provider server 20 when a response is received from integration server 30.

Interface layer 310, depicted in FIG. 3, implements functions similar to functions of interface layer 260 and transforms data from data format 270 to the format internally used by integration server 30 when a request is received from content provider server 20, and transforms data from a format internally used by integration server 30 to data format 270 when a response is sent to content provider server 20.

Interface layer 340 implements functions similar to functions of interface layer 310 and transforms data from a format internally used by integration server 30 to predetermined data format 370 used in communications between integration server 30 and merchant server 40 when a request is sent to merchant server 40, and transforms data from data format 370 to the format internally used by integration server 30 when a response is received from merchant server 40.

As described in greater detail below, in the preferred embodiment the data format 270, as well as data format 370, is well known XML format for messages defined in the Simple Object Access Protocol (SOAP) specification developed by the World Wide Web Consortium (W3C) and available from http://www.w3.org. However, it should be understood that the invention is not limited to any particular format or protocol used in communications between content provider server 20 and integration server 30 or between integration server 30 and merchant server 40. For instance, data format 270 or 370 may be HTML or DCOM binary format.

Web server 330 is a conventional, off-the-shelf web server, having features and functions such as are common to popular web servers. Web server 330 is not limited to any particular type of Web server. For instance, web server 330 might be the Microsoft Internet Information Server, available from Microsoft Corporation, Redmond, Washington, or the open source web server Apache, available from http://www.apache.org.

Server application 350 implements the business logic allowing data analysis and transformation according to the business rules as described in greater detail below.

Database 320 provides means for data storage on integration server 30 and may be implemented in a variety of fashions which are well known in the art. For example, database 320 can use computer memory to store data, or can utilize a conventional, off-the-shelf database server such as Microsoft SQL Server, available from Microsoft Corporation, Redmond, Wash.

FIG. 4 depicts merchant server 40 comprising interface layer 410, web server 430, and e-commerce server application 420.

Interface layer 410 implements functions similar to functions of interface layer 340 and transforms data from data format 370 to the format internally used by merchant server 40 when a request is received from integration server 30, and transforms data from a format internally used by merchant server 40 to data format 370 when a response is sent to integration server 30.

Web server 430 is a conventional, off-the-shelf web server, having features and functions such as are common to popular web servers. Web server 430 is not limited to any particular type of Web server. For instance, web server 430 might be the Microsoft Internet Information Server, available from Microsoft Corporation, Redmond, Washington, or the open source web server Apache, available from http://www.apache.org.

E-commerce server application 420 is a conventional e-commerce application and is not limited to any particular type of e-commerce application. For instance, e-commerce server application 420 might be the Microsoft Commerce Server, available from Microsoft Corporation, Redmond, Wash.

In the preferred embodiment, each of client computers 10, content provider servers 20, integration server 30, and merchant servers 40 are capable of communicating using a secure connection protocol, such as Secure Sockets Layer, or SSL, which provides data encryption, server authentication, message integrity, and optional client authentication for a TCP/IP connection.

In the preferred embodiment, data format 270 and data format 370 is the XML format defined in the SOAP and Web Services specifications. SOAP specification describes a communications protocol for XML Web services as well as how to represent data as XML and how to use SOAP to do Remote Procedure Calls. In recent years XML Web services, specifically distributed services that process XML-encoded SOAP messages, sent over HTTP, have become the platform for application integration, allowing applications from various sources to work together regardless of where they reside or how they were implemented.

The XML format for messages defined in the SOAP and Web Services specifications allows implementation of other enhancements to provide quality of data protection through message integrity, message confidentiality, and single message authentication. For instance, it allows implementation of the family of specifications WS-Security, WS-Trust, WS-SecureConversation, and WS-Federation, developed by International Business Machines Corporation, Armonk, N.Y., Microsoft Corporation, Redmond, Wash., and partners. These specifications are available on http://msdn.microsoft.com/webservices/understanding/specs/.

WS-Security specification defines the basic mechanisms for providing secure messaging using existing security models (Kerberos, X509, etc) and provides support for multiple security tokens, multiple trust domains, multiple signature formats, and multiple encryption technologies.

WS-Trust specification defines an extensible model for setting up and verifying trust relationships between participants in communications. WS-Trust allows Web services to set up and agree on which security servers they “trust,” and to rely on these servers.

WS-SecureConversation specification defines extensions that build on WS-Security to provide secure communication. Specifically, it defines mechanisms for establishing and sharing security contexts, and deriving session keys from security contexts.

WS-Federation allows a set of organizations to establish a single, virtual security domain. An end-user that “logs into” any member of the federation has effectively logged into all of the members. WS-Federation defines several models for providing federated security through protocols between WS-Trust and WS-SecureConversation topologies.

These and other specifications for Web Services allow accommodating a wide variety of security models and encryption technologies to implement integrity and confidentiality of messages.

Typical purchasing procedure comprises several steps: user of client computer requests a catalog from a content provider server, searches for items he/she wants to purchase, and submits the purchase order providing payment and delivery information. The content provider server communicates the purchase order to the integration server, and integration server communicates the order to a merchant server if all selected items are available from single merchant, or splits the order into several purchase orders and communicates each order to corresponding merchant server if selected items are to be provided by different merchants. Any merchant server can approve or reject the transaction. If any of merchant servers rejects the transaction, the system returns that information to the user of client computer suggesting to change the order. If all merchant servers approve their corresponding transactions, the system requests the transactions execution and returns the order confirmation to the user. Integration server records the transaction parameters and allocates credit for the content provider server. All server communications happen behind the scene and the user of client computer continues interaction with the content provider server without being distracted by visits to different merchant servers. This increases customer retention for the content provider server, thus increasing value of the system for the content provider. Each merchant gets the advantage of integration with plurality of content providers, and each content provider gets the advantage of integration with plurality of merchants by establishing single interface with the integration server, saving money and time on such integration.

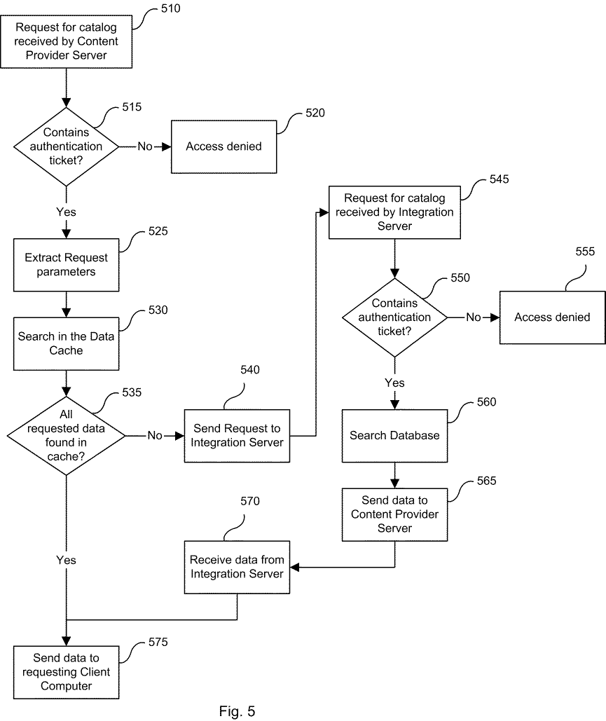

FIG. 5 is a high level diagram depicting an initial step in a purchase procedure, i.e. processing of a request for catalog sent by client computer 10 to content provider server 20. The step begins at block 510 where content provider server 20 receives a request for catalog from client computer 10. Sending this request client computer 10 expects a response from content provider server 20 comprising data describing products available for commercial transaction. For instance, the request for catalog can contain a list of parameters describing products requested for commercial transaction, or an identification of a category of products or an identification of a specific product. The format of the request may be conventional HTTP GET request or HTTP POST request if the request was created by web browser 110, or it may be an XML-encoded SOAP message if the request was created by server application 120 (FIG. 2).

Web browser 110 creates the HTTP GET request or HTTP POST request when a user clicks on a hypertext link or a button displayed by the browser 110 on the computer screen. For the purposes of user authentication the request comprises a Session ID in a cookie, or included in the body of the request. Techniques for user authentication in the HTTP conversations are known in the art and are not discussed in detail here.

Server application 120 creates the request for catalog using an XML-encoded SOAP message comprising user authentication data included in the <S:Header> tag of the message and request parameters in the <S:Body> tag of the message.

Below is a schematic example of XML-encoded SOAP message for catalog request also illustrating the use of integrity and security tokens in the <S:Header> tag as described in the WS-Security specification. For clarity purposes this example does not show all details of the request, for instance, it does not show full contents of tags <wsse:BinarySecurityToken>, <ds:DigestValue>, and <ds:SignatureValue>. In the <S:Body> tag this example message contains a request parameter ProductID identifying requested product as “book x-123”:

<S:Envelope
xmlns:S=“http://www.w3.org/2001/12/soap-envelope”
xmlns:ds=“http://www.w3.org/2000/09/xmldsig#”
xmlns:wsse=“http://schemas.xmlsoap.org/ws/2002/04/secext”
xmlns:xenc=“http://www.w3.org/2001/04/xmlenc#”><S:
Header><wsse:Security> <wsse:BinarySecurityToken Value
Type=“wsse:X509v3” Encoding-
Type=“wsse:Base64Binary” Id=“X509Token”> MIIEZ-
zCCA9CgAwIBAgIQEmtJZc0rqrKh5i...
</wsse:BinarySecurityToken>
<ds:Signature><ds:SignedInfo><ds:CanonicalizationMethod
Algorithm=
“http://www.w3.org/2001/10/xml-exc-c14n#”/><ds:Signature
Method Algorithm=
“http://www.w3.org/2000/09/xmldsig#rsa-sha1”/><ds:
Reference> <ds:Transforms><ds:Transform Algorithm=
“http://...#RoutingTransform”/><ds:Transform Algorithm=
“http://www.w3.org/2001/10/xml-exc-c14n#”/></ds:Transforms>
<ds:DigestMethod Algorithm
=“http://www.w3.org/2000/09/xmldsig#sha1”/>
<ds:DigestValue>EULddytSo1...</ds:DigestValue></ds:Reference>
</ds:SignedInfo><ds:SignatureValue>BL8jdfToEb1l/vXcM
ZNNjPOV...
</ds:SignatureValue><ds:KeyInfo><wsse:SecurityTokenReference>
<wsse:Reference
URI=“#X509Token”/></wsse:SecurityTokenReference></
ds:KeyInfo></ds:Signature>
</wsse:Security></S:Header><S:Body><c:Request
xmlns:c=“http://solonchev.com/2003/ecommerce”><c:Product
ID>book x-123</c:ProductID></c:Request
></S:Body></S:Envelope>

Techniques of creating of XML-encoded SOAP messages, appending integrity and security tokens, and requestor authentication are known in the art and are not discussed in detail here.

It should be understood that the above example of XML-encoded SOAP message is also an example of data format 270 (FIG. 2) used in communications between content provider server 20 and integration server 30, and data format 370 (FIG. 3) used in communications between integration server 30 and merchant server 40.

Referring to FIG. 2, web server 230 forwards client requests to server components for processing. Interface layer 210a processes HTTP POST or GET request created by web browser application 110. Interface layer 210b processes SOAP request created by server application 120. Both layers 210a and 210b extract data from the request and transform the data into the binary form used internally by server application 250. As depicted in FIG. 5, server application 250 verifies the existence and validity of the requestor authentication data in the request (block 515 in FIG. 5), making a decision to allow (go to block 525) or deny (block 520) access to the server according to rules predetermined by the server administrator using techniques well-known in the art and not discussed in detail here.

When the access to the system is allowed, server application 250 extracts request parameters defining a product or products requested by the client. Thus in the XML example above, parameter ProductID defines a product “book x-123”. Server application 250 than performs search for the products in data cache 240 (block 530). If the requested data is found in data cache 240 server application 250 creates a response for the client comprising found catalog data.

Interface layer 210a transforms the response to the HTML representation of the catalog, having products description, picture, price, and other relevant data, and web server 230 sends this response to the client computer 10a using HTTP protocol (block 575). Techniques of creating HTML representation of catalog are known in the art and are not discussed in detail here.

Accordingly, interface layer 210b transforms the response to the XML representation of the catalog, having products description, picture, price, and other relevant data, encapsulates it into SOAP message, and web server 230 sends this response to client computer 10b using HTTP or TCP/IP protocol (block 575). Techniques of creating XML representation of catalog and encapsulating it into SOAP message are known in the art and are not discussed in detail here.

If the data is not found in the cache 240 the server application 250 creates another request for catalog which comprises parameters submitted by the client and will be sent to integration server 30. Interface layer 260 transforms the new request to data format 270 and web server 230 sends requests to integration server 30 (block 540).

Processing of this request by integration server 30 starts with receiving the request and transforming it by interface layer 310 (FIG. 3) from data format 270 into the binary format used internally by server application 350 (block 545). Server application 350 verifies the existence and validity of the requestor authentication data in the request (block 550), making a decision to allow (go to block 560) or deny (block 555) access to the system according to rules predetermined by the server administrator using techniques well-known in the art and not discussed in detail here.

When the access to the system is allowed, server application 350 extracts request parameters defining a product or products requested by content provider server 20 and performs search for the products in database 320 (block 560).

After finishing the search server application 350 creates a response comprising catalog data found in the database 320. Interface layer 310 transforms the response to the XML representation of the catalog, having products description, picture, price, and other relevant data, encapsulates it into SOAP message, and web server 330 sends this response to content provider server 20 using HTTP or TCP/IP protocol (block 565).

Upon receiving a response from integration server 30, interface layer 260 extracts data from the response and transforms the data into the binary form used internally by server application 250 (block 570). Server application 250 populates data cache 240 with the data received from integration server 30 and creates a response for the client comprising found catalog data. The response is transformed by interface layer 210a or 210b and is sent to the client computer 10a or 10b accordingly as described above.

It should be understood that data cache 240 is an optional component of content provider server 20, and content provider server 20 can be configured to communicate all requests for catalog to integration server 30 without performing search or storing data in cache 240.

After receiving the response comprising data describing products available for commercial transaction, client requests a commercial transaction for selected products. For example, user of client computer 10a can browse list of products displayed by web browser 110, select some products for purchase, place those products in an electronic shopping cart, provide delivery and payment information, and submit the order for transaction. Techniques for providing user interaction with electronic catalogs and shopping carts are known in the art and are not discussed in detail here.

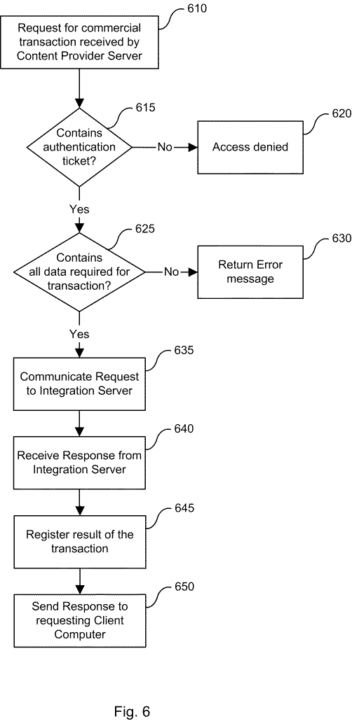

FIG. 6 is a high level diagram depicting processing of the request for commercial transaction by content provider server 20.

The processing begins at block 610 where content provider server 20 receives a request for commercial transaction from client computer 10. The request comprises list of items selected for commercial transaction, purchaser data, and payment and delivery information. The format of the request may be conventional HTTP GET request or HTTP POST request if the request was created by web browser 110, or it may be an XML-encoded SOAP message if the request was created by server application 120 (FIG. 2).

Web browser 110 creates the HTTP GET request or HTTP POST request when a user clicks on a hypertext link or a button displayed by the browser 110 on the computer screen. For the purposes of user authentication the request comprises a Session ID in a cookie, or included in the body of the request. Techniques for user authentication in the HTTP conversations are known in the art and are not discussed in detail here.

Server application 120 creates the request for catalog using an XML-encoded SOAP message comprising user authentication data included in the <S:Header> tag of the message and request parameters in the <S:Body> tag of the message.

Content provider server 20 verifies the existence and validity of the requestor authentication data in the request (block 615 in FIG. 6), making a decision to allow (go to block 625) or deny (block 620) access to the server according to rules predetermined by the server administrator using techniques well-known in the art and not discussed in detail here.

Than content provider server 20 verifies if the request contains all data required for the requested commercial transaction (block 625). Typically the request should comprise list of items and quantity to be purchased, purchaser name and address, payment information, for example credit card number and expiration date, and delivery address. If any required piece of information is missed, content provider server 20 returns error message to requesting client computer 10 (block 630). If all required information is present content provider server 20 communicates the request to integration server 30 (block 635) and waits for a response. Upon receiving the response from integration server 30 (block 640) content provider server 20 registers the result of the requested commercial transaction (block 645) and communicates the response to requesting client computer 10 (block 650).

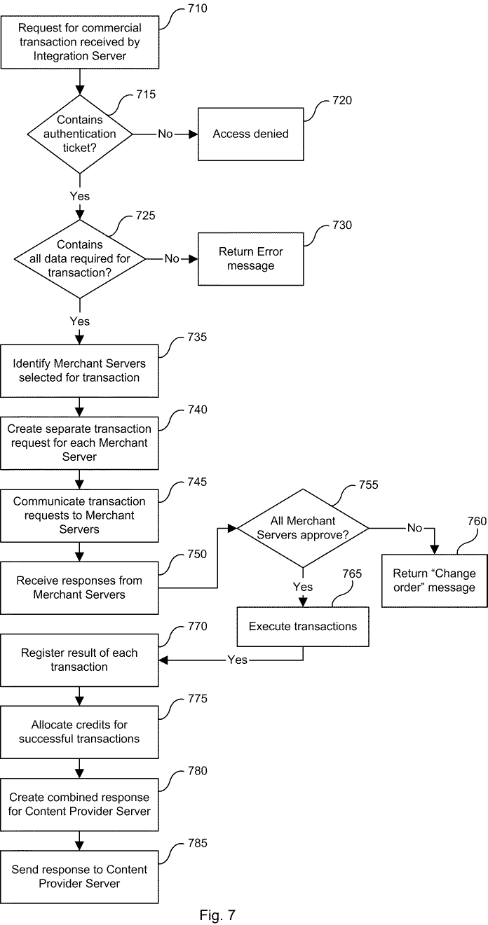

FIG. 7 is a high level diagram depicting processing of the request for commercial transaction by integration server 30.

After receiving the request for commercial transaction from content provider server 20 (block 710) integration server 30 verifies the existence and validity of the requestor authentication data in the request (block 715), making a decision to allow (go to block 725) or deny (block 720) access to the server according to rules predetermined by the server administrator using techniques well-known in the art and not discussed in detail here. Than integration server 30 verifies if the request contains all data required for the requested commercial transaction (block 725). If any required piece of information is missed, integration server 30 returns error message to content provider server 20 (block 730). If all required information is present integration server 30 compares the list of item requested for commercial transaction with the content of the catalog stored in the database 320 (FIG. 3) and identifies merchants offering those items and their corresponding merchant servers 40 (block 735). For each identified merchant server 40 integration server 30 creates separate transaction request comprising items offered by that merchant (block 740) and communicates each request to corresponding merchant server 40 (block 745). Every identified merchant server returns a response signaling if this merchant server is able to execute requested transaction. Upon receiving the responses from all merchant servers involved in the transaction (block 750) integration server 30 verifies if all merchant servers report the ability to execute requested transaction (block 755). If any of identified merchant servers rejects transaction integration server 30 returns “Change order” message to content provider server 20 (block 760). If all identified merchant servers approve execution of requested transaction integration server 30 sends requests for transactions execution to all identified merchant servers (block 765), registers details and result of each transaction (block 770), allocates credit to content provider server 20 requested the transaction (block 775), creates response for content provider server 20 (block 780), and communicates this created request to content provider server 20 (block 785).

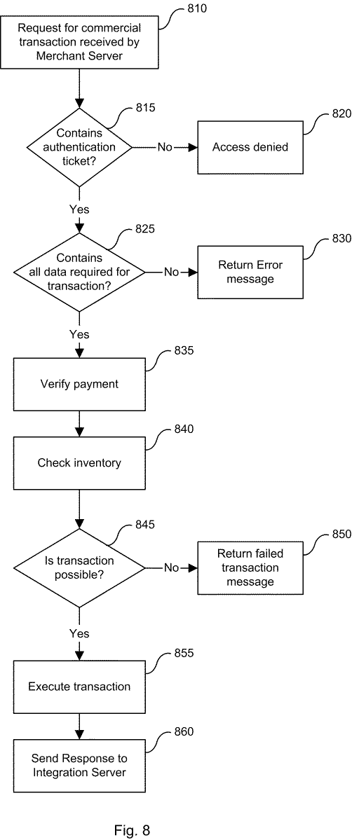

FIG. 8 is a high level diagram depicting processing of the request for commercial transaction by merchant server 40.

After receiving the request for commercial transaction from integration server 30 (block 810) merchant server 40 verifies the existence and validity of the requester authentication data in the request (block 815), making a decision to allow (go to block 825) or deny (block 820) access to the server according to rules predetermined by the server administrator using techniques well-known in the art and not discussed in detail here. Than merchant server 40 verifies if the request contains all data required for the requested commercial transaction (block 825). If any required piece of information is missed, merchant server 40 rejects the transaction and returns error message to integration server 30 (block 830). If all required information is present merchant server 40 verifies purchaser, payment, delivery, and other relevant data in the request (block 835), and checks the inventory (block 840) to determine if the requested transaction can be executed (block 845). Functions 835 and 840 are common for existing e-commerce applications and are not discussed in detail here. If requested transaction can not be executed merchant server 40 rejects the transaction and returns error message to integration server 30 (block 850). If merchant server 40 approves the transaction it returns approval response to integration server 30. When merchant server 40 receives requests for transactions execution it executes transaction (block 855) and sends confirmation to integration server 30 (block 860).

The invention provides the ability of seamless integration of the plurality of content provider servers with the plurality of merchant servers into a single electronic commerce system, while permitting a content provider to obtain commercial advantages of better customer retention combined with the presentation of plurality of merchants on the content provider server, as well as permitting a merchant to obtain commercial advantages of the presentation of merchant's products on plurality of the content provider servers.

While the above description contains many specificities, these should not be construed as limitations on the scope of the invention, but rather as an exemplification of one preferred embodiment thereof. Other variations are possible. For example, content provider server can provide to the client computer information regarding only one item available for commercial transaction, or merchant server can use product catalog stored in the database on the integration server as the merchant's primary inventory system.

Accordingly, the scope of the invention should be determined not by the embodiment illustrated, but by the appended claims and their legal equivalents.

1. An electronic system for initiating and tracking commercial transactions, comprising:
at least one client computer;
at least one content provider server;
a first network connection connecting said client computer to said content provider server;
at least one merchant server programmed to provide the ability to execute commercial transactions;
an integration server having a database and programmed to identify said content provider server and to identify said merchant server, a second network connection connecting said content provider server to said integration server;
a third network connection connecting said merchant server to said integration server; wherein said integration server is further programmed to store in said database a product catalog comprising information regarding products available for commercial transaction, and to communicate information from said database to said content provider server using said second network connection;
and said content provider server is programmed to request from said integration server an information regarding products available for commercial transaction, and to communicate said information regarding products available for commercial transaction to said client computer using said first network connection, and to receive from said client computer an integrated transaction request comprising an information regarding items selected for a commercial transaction, and to communicate said integrated transaction request to said integration server;
and said integration server is further programmed to create a merchant transaction request comprising an information regarding items selected for the commercial transaction on said merchant server, and to communicate said merchant transaction request to said merchant server.

2. The system of claim 1 wherein said integration server is further programmed to store an information identifying said content provider server, and to store an information identifying said merchant server.

3. The system of claim 2 wherein said integration server is further programmed to receive from said merchant server a transaction response comprising information regarding a result of said commercial transaction, and to communicate said transaction response to said content provider server.

4. The system of claim 3 wherein said integration server is further programmed to record said transaction response and to use said transaction response to allocate credit to said content provider server.

5. The system of claim 4 wherein said integration server is further programmed to provide the ability to select a group of products from said database and to allow said content provider server access only to the selected group of products.

6. The system of claim 5 wherein said content provider server is further programmed to store information regarding said selected group of products.

7. The system of claim 5 wherein said merchant server is further programmed to communicate to said integration server an information regarding products allowed to be transacted by said content provider server.

8. A method of initiating and tracking commercial transactions, comprising the steps of:
identifying at least one content provider server to an integration server having a database comprising an information regarding products available for commercial transactions;
communicating said information regarding products available for commercial transaction to said content provider server;
communicating said information regarding products available for commercial transaction from said content provider server to a client computer;
receiving from said client computer an integrated transaction request comprising an information regarding items selected for a commercial transaction;
communicating said integrated transaction request to said integration server;
identifying at least one merchant server to said integration server;
creating a merchant transaction request comprising an information regarding items selected for the commercial transaction on the identified merchant server;
communicating said merchant transaction request to said merchant server;
executing requested transaction on said merchant server.

9. The method of claim 8 further comprising storing information identifying said merchant server and information identifying said content provider server on said integration server.

10. The method of claim 9 further comprising identifying a group of products in said database and limiting access of said content provider server to the identified group of products.

11. The method of claim 10 further comprising storing said identified group of products on said content provider server.
